(19) United States
(12) Patent Application Publication
(10) Pub. No.: US 2015/0037087 A1
(43) Pub. Date: Feb. 5, 2015

(54) Lead-Free Solder Alloy

(71) Applicant: Senju Metal Industry Co., Ltd., Tokyo (JP)

(72) Inventors: Ken Tachibana, Tokyo (JP); Hikaru Nomura, Tokyo (JP); Kyu-oh Lee, Chandler, AZ (US)

(73) Assignee: Senju Metal Industry Co., Ltd., Tokyo (JP)

(21) Appl. No.: 13/959,224

(22) Filed: Aug. 5, 2013

(51) Int. Cl. B23K 35/26

(52) U.S. Cl. CPC B23K 35/262; B23K 35/264; B23K 2201/38
USPC 403/272; 420/577; 420/561

(57) ABSTRACT

A lead-free solder alloy consisting essentially of, in mass percent, Bi: 31-59%, Sb: 0.15-0.75%, at least one element selected from Cu: 0.3-1.0% and P: 0.002-0.055%, and a balance of Sn has a low melting point for suppressing warping of a thin substrate during soldering. It can form solder joints with high reliability even when used for soldering to electrodes having a Ni coating which contains P, since the growth of a P-rich layer is suppressed so that the shear strength of the joints is improved and the alloy has a high ductility and a high tensile strength.

### TECHNICAL FIELD

This invention relates to a Sn—Bi—Sb based lead-free solder alloy and particularly a Sn—Bi—Sb based lead-free solder alloy having excellent bonding reliability.

### BACKGROUND ART

In recent years, electronic equipment such as cellular phones is becoming smaller and thinner. In electronic parts such as semiconductor devices used in such electronic equipment, thin substrates having a thickness from around several millimeters to 1 mm or less are now being used.

Sn—Ag—Cu solder alloys have been widely used as lead-free solders. Sn—Ag—Cu solder alloys have a relatively high melting point, which is around 220° C. even for a eutectic Sn-3Ag-0.5Cu solder alloy. Therefore, when soldering of electrodes to thin substrates like those described above is carried out using a Sn—Ag—Cu solder alloy, the substrates sometimes warp due to the heat at the time of soldering, leading to the occurrence of bonding defects.

As a countermeasure against such bonding defects, warping of thin substrates can be suppressed and bonding reliability can be improved by carrying out soldering at lower temperatures. Sn—Bi solder alloys are known as low melting point solder alloys which can be used for this purpose. Among Sn—Bi solder alloys, a Sn-58Bi solder alloy has a very low melting point of around 140° C., and it can suppress warping of substrates.

However, Bi is inherently a brittle element, and Sn—Bi solder alloys are also brittle. Even if the Bi content of a Sn—Bi solder alloy is reduced, due to segregation of Bi, the alloy becomes brittle. Solder joints which are obtained by soldering using Sn—Bi solder alloys may develop cracks due to their brittleness when large stresses are applied, and their mechanical strength may deteriorate.

In order to cope with reductions in the size of electronic parts, it is necessary to decrease the area of substrates used therein. Reduction in the size of substrates makes it necessary to realize a reduction in the size of the electrodes on the substrates and a reduction in the pitch of the electrodes to a very small value of around several tens of micrometers. Reducing the size of electrodes causes the amount of solder alloy used for soldering each electrode to decrease, resulting in a decrease in the mechanical strength of solder joints.

Due to these problems, there have been attempts to improve various properties including mechanical strength of Sn—Bi solder alloys, which exhibit low melting points capable of suppressing warping of substrates, by adding some element or elements to the alloys.

Patent Document 1 discloses adding Sb to a Sn—Bi solder alloy, thereby improving the ductility of the alloy.

Patent Document 2 discloses adding Sb and Ga to a Sn—Bi solder alloy, thereby reducing the brittleness and increasing the bonding strength of Sn—Bi solder alloys.

Patent Document 3 discloses suppressing Cu erosion of electrodes by addition of Cu to a Sn—Bi solder alloy and increasing the mechanical strength of the solder alloy by addition of Sb.

Patent Document 4 discloses that addition of Ag, Cu, In, and Ni as essential elements to a Sn—Bi solder alloy reduces a decrease in elongation and mechanical fatigue properties expressed by the length of time until the occurrence of cracks (the crack occurrence life). In addition, it discloses that addition of Sb decreases the crack occurrence life.

As stated above, decreases in the size of electronic parts in recent years have led to a decrease in the size of solder joints. As a result, the amount of solder paste used for connection of each electrode has become smaller, resulting in a decrease in the bonding strength of solder joints. In this respect, Patent Document 5 discloses a solder bonding material comprising a Sn—Bi based solder alloy and a thermosetting adhesive which is added to supplement the bonding strength of the solder alloy. The thermosetting adhesive may be used in the form of a thermosetting adhesive composition which further contains a thixotropic agent, a curing agent, and a flux.

### PRIOR ART DOCUMENTS

### Patent Documents

Patent Document 1: JP 2010-167472 A

Patent Document 2: JP 07-040079 A

Patent Document 3: JP 11-320177 A

Patent Document 4: JP 2004-017093 A

Patent Document 5: JP 2007-090407 A

### SUMMARY OF THE INVENTION

Electrodes of an electronic part which are typically made of copper (Cu) are often treated by electroless Ni plating followed by electroless plating with a noble metal such as Au plating or a combination of Pd plating and subsequent Au plating. Au plating is formed in order to protect the underlying Ni plating against oxidation and improve the surface wettability by molten solder.

Electroless Ni plating typically forms a Ni coating containing an appreciable amount of phosphorus (P) mainly derived from the reducing agent (e.g., sodium hypophosphite) used for electroless plating. Usually such Ni coating has a P content of at least a few percent by mass, for example from 2 to 15 mass %.

In the solder alloys disclosed in Patent Documents 1 and 2, if soldering is carried out on electrodes treated by electroless Ni plating, due to the diffusion coefficient of Ni into the solder alloy which is larger than the diffusion coefficient of P, Ni in the plated coating preferentially diffuses into the solder alloy, and P precipitates in the interface with the solder joint in a greater proportion than Ni, leading to the formation of a so-called P-rich layer in the interface. Even when a noble metal coating such as an Au coating is present atop the Ni coating to form a Ni/Au plating, preferential diffusion of Ni occurs since the Au or other noble metal coating is extremely thin and does not inhibit diffusion of Ni as discussed later. The P-rich layer is hard and brittle, and it deteriorates the shear strength of a solder joint. When a solder joint having such a P-rich layer fractures by shearing, the Ni plating layer is often exposed, indicating that the fracture occurs by detachment of the P-rich layer from the electrode rather than by a fracture of the solder joint itself. Therefore, the formation of a P-rich layer adversely affects the bonding reliability of a solder joint.

Patent Document 3 states an effect of the addition of Sb or Cu, but the content of these elements is not clear, and the effect of adding Sb has not been proved by experimental data. In addition, there is no mention in that document of an increase in the mechanical strength of the solder joint produced by the addition of Cu.

Patent Document 4 discloses that when both Sb and Cu are added, there is a tendency for shortening of the crack occurrence life to be promoted, and that the addition of In as an essential element produces an increase in elongation. However, there is no mention in that document that the ductility of a solder alloy or the mechanical strength of a solder joint is improved by addition of Sb and Cu.

Patent Document 5 discloses a solder bonding material comprising a Sn—Bi based solder alloy and a thermosetting resin wherein the solder alloy may further contain Sb and Cu. It is mentioned therein that Sb and Cu can be added in order to suppress coarsening of the structure of the solder alloy and obtain a long lifespan. There is no evidence in Patent Document 5 that the ductility or tensile strength of the solder alloy is improved or that the shear strength of a solder joint is improved by the addition of Sb and Cu. Furthermore, it is unclear what specific alloy composition and what mixing ratio of components can provide the desired effect.

The object of the present invention is to provide a Sn—Bi—Sb based lead-free solder alloy which is capable of forming a solder joint with improved bonding reliability by having a low melting point sufficient to suppress warping of a substrate during soldering, along with good ductility and a high tensile strength, and by suppressing the formation of a P-rich layer in the bonding interface during soldering to an electrode treated by electroless Ni plating, thereby improving the shear strength of the joint.

The present inventors paid attention to the fact that in the case of soldering to electrodes having a P-containing Ni coating typically formed by electroless Ni plating, the diffusion coefficient of Ni into a solder alloy is larger than the diffusion coefficient of P, and found that it is possible to suppress the growth of a P-rich layer by suppressing diffusion of Ni into a solder alloy during soldering.

In order to achieve this goal, the present inventors found that by adding one or both of Cu and P to a Sn—Bi—Sb solder alloy, the growth of a P-rich layer is significantly suppressed by suppression of diffusion of Ni while maintaining the low melting point, good ductility, and a high tensile strength of the solder alloy, thereby making it possible to markedly improve the shear strength of the solder alloy. As a result, improved bonding reliability can be achieved, and at the same time warping of a thin substrate at the time of soldering can be reduced.

The present invention is a lead-free solder alloy having an alloy composition consisting essentially of, in mass percent, Bi: 31-59%, Sb: 0.15-0.75%, at least one element selected from Cu: 0.3-1.0% and P: 0.002-0.055%, and a balance of Sn.

A lead-free solder alloy according to the present invention is particularly suitable for use in soldering to electrodes which have been treated by electroless Ni plating and which are formed on a thin substrate having a thickness of at most 5 mm and preferably at most 3 mm and most preferably at most 2 mm, since the effects of the present invention are most significantly exhibited. Namely, warping of the thin substrate during soldering can be minimized due to the low melting point of the solder alloy. In addition, the bonding reliability of a solder joint can be improved particularly due to suppression of growth of a P-rich layer in the bonding interface which deteriorates the shear strength of the solder joint and due to good ductility (elongation) and a high tensile strength of the solder alloy.

### BRIEF EXPLANATION OF THE DRAWINGS

FIG. 1 is a SEM photograph of the surface of an electrode after soldering was carried out using a Sn-58Bi solder alloy on a Cu electrode treated by electroless Ni/Au plating and the resulting solder joint was removed by shearing.

FIGS. 2(a) and 2(b) are SEM photographs of cross sections in the vicinity of the interface between a solder joint and an electrode when a solder joint was formed by soldering of a Cu electrode which had undergone electroless Ni/Au plating using, respectively, a conventional Sn-58Bi alloy and a Sn-40Bi-0.5Sb-0.5Cu alloy according to the present invention, and FIGS. 2(c) and 2(d) are SEM photographs of cross sections in the vicinity of the interface between a solder joint and an electrode when a solder joint was formed by soldering of a Cu electrode which had undergone electroless Ni/Pd/Au plating using, respectively, a conventional Sn-58Bi alloy and a Sn-40Bi-0.5Sb-0.5Cu alloy according to the present invention.

### MODES FOR CARRYING OUT THE INVENTION

Below, the present invention will be explained in greater detail. In the following explanation, percent with respect to a solder alloy composition means mass percent unless otherwise specified.

A lead-free solder alloy according to the present invention is a Sn—Bi—Sb solder alloy which further contains Cu and/or P. The solder alloy exhibits the low melting point and high ductility which are inherent properties of a Sn—Bi—Sb solder alloy. Furthermore, particularly when it is used for soldering of an electrode which has been subjected to electroless Ni plating such as electroless Ni/Au plating or Ni/Pd/Au plating, the solder alloy suppresses the growth of a brittle P-rich layer by suppressing diffusion of Ni into the solder alloy and greatly improves the shear strength of a solder joint. As a result, a lead-free solder alloy according to the present invention can guarantee excellent joint reliability (bonding reliability of a solder joint) while suppressing warping of a thin substrate during soldering.

As mentioned previously, electroless Ni plating is typically followed by Au plating or other plating with a noble metal or metals such as Pd/Au plating. Thus, an Au plating layer is formed atop a Ni plating layer. However, such Au plating layer or other noble metal layer has an extremely small thickness of around 0.05 μm and disappears during soldering by diffusion into a solder alloy. Therefore, in the present invention, there is no particular need to take the Au plating or other noble metal plating into consideration when evaluating various properties.

A solder alloy according to the present invention has the following alloy composition.

The Bi content is 31-59%. Bi lowers the melting point of a solder alloy. If the Bi content is lower than 31%, the melting point of the solder alloy increases and warping of a substrate may occur at the time of soldering. If the Bi content is higher than 59%, the tensile strength and ductility of a solder alloy deteriorate due to precipitation of Bi. The Bi content is preferably 32-58% and more preferably 35-58%.

The Sb content is 0.15-0.75%. Sb increases the ductility of a solder alloy. If the Sb content is lower than 0.15%, ductility (elongation) deteriorates, while if the Sb content is greater than 0.75%, ductility decreases due to the formation of Sb compounds. The Sb content is preferably 0.2-0.75% and more preferably 0.2-0.7%.

The Cu content is 0.3-1.0%. Cu suppresses the growth of a P-rich layer which forms in the interface between a Ni plated layer formed by electroless Ni plating and a solder joint. If the Cu content is less than 0.3%, it is not possible to suppress the formation of a P-rich layer, and the shear strength decreases. If the Cu content is larger than 1.0%, intermetallic compounds of Sn with Cu are excessively formed in the solder alloy and the ductility of the solder alloy decreases. In addition, a Cu content exceeding 1.0% markedly increases the melting point of a solder alloy and worsens the wettability of the solder alloy. Furthermore, operability is worsened due to the occurrence of warping of a substrate. The Cu content is preferably 0.3-0.8% and more preferably 0.3-0.7%.

The P content is 0.002-0.055%. Like Cu, P suppresses the growth of a P-rich layer. If the P content is less than 0.002%, it is not possible to suppress the formation of a P-rich layer, and the shear strength decreases. If the P content is higher than 0.055%, particularly when using Cu electrodes or when the solder alloy contains Cu, compounds of Sn, Cu, and P form in the solder alloy or in the joint interface, and the shear strength decreases. The P content is preferably 0.003-0.055% and more preferably 0.003-0.05%.

Thus, Cu and Ni both have the effect of suppressing the diffusion of Ni into the solder alloy and suppressing the growth of a P-rich layer, thereby markedly improving the shear strength of a solder joint when they are added to a Sn—Bi—Sb lead-free solder alloy, particularly in soldering of an electrode having an electroless Ni plating layer formed thereon. In the present invention, it is possible to add only one of Cu and P or add both of Cu and P. From the standpoint of avoiding with certainty the formation of a phosphorus compound which may occur when a solder alloy has a high P content, it is preferable to preferentially add Cu to P.

With a solder joint formed on an electrode having an electroless Ni plating layer using a lead-free solder alloy according to the present invention, when the solder joint is sheared off, the electroless Ni plating layer is not exposed.

As stated above, the lead-free solder alloy according to the present invention can suppress the diffusion of Ni contained in the electroless plating layer into the solder alloy, thereby suppressing the growth of a P-rich layer which is formed on the surface of the plating layer. As a result, the solder alloy can markedly improve the mechanical properties and particularly the shear strength of the joint interface.

A lead-free solder alloy according to the present invention can be used in the form of a preform, a wire, a solder paste, a solder ball, or the like. A lead-free solder alloy according to the present invention has a high shear strength in addition to a high tensile strength and ductility. Therefore, when it is used in the form of a solder ball, it can be made into a solder ball which is smaller than a conventional solder ball. As a result, it can adequately cope with decreases in the size of substrates used in electronic parts and the like.

A lead-free solder alloy according to the present invention can be used to connect the electrodes of a package such as an IC chip to the electrodes of a substrate such as a printed circuit board (PCB). As stated above, a lead-free solder alloy according to the present invention has an increased shear strength while maintaining a high ductility and a high tensile strength. Therefore, even a substrate slightly warps at the time of reflow of the solder during soldering, there is no fracture in the interface between the electrodes and the solder joints. As a result, a lead-free solder alloy according to the present invention can guarantee excellent joint reliability even when used with a substrate which is thinner than is conventional.

### EXAMPLES

The solder alloys having compositions shown in Table 1 were prepared. The melting point, the tensile strength, the elongation (ductility), the thickness of a P-rich layer, the shear strength, and the percent exposure of plating were determined for these solder alloys as described below. The results are also shown in Table 1.

### Melting Point of the Solder Alloy

The melting point (° C.) of each solder alloy was measured using a differential scanning calorimeter (DSC) (Model DSC 6200 of Seiko Instruments, Inc.) at a rate of temperature increase of 5° C. per minute.

### Tensile Strength and Elongation (Ductility)

The solder alloys having compositions shown in Table 1 were formed into test specimens for a tensile test, and the tensile strength (MPa) and the elongation (%) of the specimens were measured using a tensile strength tester (Auto Graph AG-201kN manufactured by Shimadzu Corporation) at a stroke speed of 6.0 mm per minute and a strain rate of 0.33% per second. A solder alloy having a tensile strength of at least 70 MPa and elongation of at least 70% can be used without any practical problems.

### Thickness of a P-Rich Layer

The solder alloys having compositions shown in Table 1 were soldered to Cu electrodes of a PCB having a thickness of 1.2 mm. Each of the electrodes had a diameter of 0.3 mm and had treated by electroless Ni/Au plating in a conventional manner. Soldering was carried out by placing a solder ball with a diameter of 0.3 mm prepared from each solder alloy on each of the electrodes of the circuit board using a water soluble flux (WF-6400 manufactured by Senju Metal Industry Co., Ltd.) and then carrying out reflow soldering with a reflow profile having a peak temperature of 210° C. to obtain a sample having solder joints.

The thickness of a P-rich layer (μm) of each sample was determined by observing a cross section of the sample in the vicinity of the bonding interface between the solder joint and the Ni plating layer under a SEM, analyzing the resulting SEM image using an image analyzer (JSM-7000F manufactured by JEOL,

Ltd.) to identify a P-rich layer which is shown by a different color from other layers, and measuring the thickness of the identified P-rich layer. The thickness of the P-rich layer was measured in the same manner for 5 samples which were prepared under the same conditions, and the average value was made the thickness of the P-rich layer.

### Shear Strength

The solder alloys having compositions shown in Table 1 were used for soldering to PCB electrodes which were similar to the electrodes used for measurement of the thickness of a P-rich layer and which were either untreated Cu electrodes or Cu electrodes which had undergone electroless Ni/Au plating to form solder joints. The shear strength (N) of the solder joints was measured using a high speed bond tester (Series 4000HS manufactured by Dage Corporation) at 1000 mm per second. A shear strength of at least 2.21 N for unplated Cu electrodes and a shear strength of at least 2.26 N for Cu electrodes with electroless Ni/Au plating are considered acceptable for actual use.

### Percent Exposure of Plating

After the shear strength test of the solder alloys by soldering to PCB electrodes having a Ni/Au plating layer, a SEM photograph was taken of the surface of the electrodes from which the solder joints had been removed by shearing as a result of the test. EDS analysis was performed on the photograph to identify the region where Ni plating was exposed, and the area of this region was measured using image analysis software (Scandium) provided by Seika Corporation. The area of the region where Ni plating was exposed was divided by the overall area of the electrode to calculate the percent exposure of plating.

TABLE 1

| | | | | | | | | | | Thickness | Shear strength | | % Exposure |
|---|---|---|---|---|---|---|---|---|---|---|---|---|---|
| | | | | | | | | | | of P- | (N) | | of |
| | | | | | | | | | | rich | | Electroless | plating |
| | Alloy Composition (mass %) | | | | | | M.P. | TS | El | layer | Cu | Ni/Au | (Ni/Au |
| | Sn | Ag | Bi | Sb | Cu | P | (° C.) | (MPa) | (%) | (μm) | electrode | plating | plating) |
| Ex. 1 | bal. | 0 | 35 | 0.2 | 0.3 | 0 | 183.2 | 79.4 | 79.1 | 0.014 | 2.61 | 2.47 | 0 |
| Ex. 2 | bal. | 0 | 35 | 0.5 | 0.5 | 0 | 183.6 | 80.3 | 78.9 | 0.012 | 2.66 | 2.51 | 0 |
| Ex. 3 | bal. | 0 | 35 | 0.7 | 0.7 | 0 | 184.6 | 80.1 | 77.7 | 0.011 | 2.85 | 2.69 | 0 |
| Ex. 4 | bal. | 0 | 40 | 0.2 | 0.3 | 0 | 174.6 | 76.1 | 88.1 | 0.013 | 2.56 | 2.77 | 0 |
| Ex. 5 | bal. | 0 | 40 | 0.5 | 0.5 | 0 | 173.5 | 75.8 | 92.3 | 0.014 | 2.55 | 2.96 | 0 |
| Ex. 6 | bal. | 0 | 40 | 0.7 | 0.7 | 0 | 174.5 | 76.6 | 90.4 | 0.012 | 2.63 | 2.66 | 0 |
| Ex. 7 | bal. | 0 | 45 | 0.2 | 0.3 | 0 | 165.7 | 76.7 | 74.9 | 0.011 | 2.31 | 2.67 | 0 |
| Ex. 8 | bal. | 0 | 45 | 0.5 | 0.5 | 0 | 165.1 | 76.1 | 80.4 | 0.010 | 2.33 | 2.63 | 0 |
| Ex. 9 | bal. | 0 | 45 | 0.7 | 0.7 | 0 | 166.9 | 75.9 | 76.1 | 0.014 | 2.49 | 2.81 | 0 |
| Ex. 10 | bal. | 0 | 58 | 0.2 | 0.3 | 0 | 139.8 | 72.1 | 71.8 | 0.010 | 2.43 | 2.77 | 0 |
| Ex. 11 | bal. | 0 | 58 | 0.5 | 0.5 | 0 | 140.7 | 71.6 | 73.6 | 0.012 | 2.34 | 2.99 | 0 |
| Ex. 12 | bal. | 0 | 58 | 0.7 | 0.7 | 0 | 140.6 | 72.0 | 73.9 | 0.012 | 2.55 | 2.95 | 0 |
| Ex. 13 | bal. | 0 | 35 | 0.5 | 0 | 0.003 | 183.9 | 78.9 | 79.1 | 0.021 | 2.42 | 2.26 | 0 |
| Ex. 14 | bal. | 0 | 35 | 0.5 | 0 | 0.02 | 184.2 | 76.1 | 77.3 | 0.016 | 2.45 | 2.43 | 0 |
| Ex. 15 | bal. | 0 | 35 | 0.5 | 0 | 0.05 | 185.2 | 76.5 | 77.1 | 0.013 | 2.51 | 2.31 | 0 |
| Ex. 16 | bal. | 0 | 40 | 0.5 | 0 | 0.003 | 174.9 | 75.3 | 88.8 | 0.022 | 2.33 | 2.49 | 0 |
| Ex. 17 | bal. | 0 | 40 | 0.5 | 0 | 0.02 | 174.6 | 74.7 | 90.4 | 0.015 | 2.26 | 2.63 | 0 |
| Ex. 18 | bal. | 0 | 40 | 0.5 | 0 | 0.05 | 175.7 | 76.1 | 89.9 | 0.011 | 2.31 | 2.59 | 0 |
| Ex. 19 | bal. | 0 | 45 | 0.5 | 0 | 0.003 | 166.6 | 75.1 | 78.3 | 0.021 | 2.21 | 2.43 | 0 |
| Ex. 20 | bal. | 0 | 45 | 0.5 | 0 | 0.02 | 166.4 | 75.8 | 78.8 | 0.015 | 2.30 | 2.66 | 0 |
| Ex. 21 | bal. | 0 | 45 | 0.5 | 0 | 0.05 | 166.8 | 75.9 | 78.0 | 0.012 | 2.23 | 2.75 | 0 |
| Ex. 22 | bal. | 0 | 58 | 0.5 | 0 | 0.003 | 140.6 | 70.4 | 75.3 | 0.013 | 2.26 | 2.53 | 0 |
| Ex. 23 | bal. | 0 | 58 | 0.5 | 0 | 0.02 | 139.7 | 70.7 | 75.1 | 0.015 | 2.29 | 2.67 | 0 |
| Ex. 24 | bal. | 0 | 58 | 0.5 | 0 | 0.05 | 139.9 | 70.9 | 74.8 | 0.012 | 2.22 | 2.87 | 0 |
| Ex. 25 | bal. | 0 | 35 | 0.2 | 0.3 | 0.003 | 183.5 | 79.9 | 78.6 | 0.010 | 2.74 | 2.60 | 0 |
| Ex. 26 | bal. | 0 | 35 | 0.5 | 0.5 | 0.02 | 184.0 | 80.4 | 79.2 | 0.012 | 2.75 | 2.78 | 0 |
| Ex. 27 | bal. | 0 | 35 | 0.7 | 0.7 | 0.05 | 184.2 | 78.3 | 78.4 | 0.011 | 2.75 | 2.67 | 0 |
| Ex. 28 | bal. | 0 | 40 | 0.2 | 0.3 | 0.003 | 174.4 | 76.1 | 89.8 | 0.011 | 2.64 | 2.78 | 0 |
| Ex. 29 | bal. | 0 | 40 | 0.5 | 0.5 | 0.02 | 174.1 | 75.8 | 90.1 | 0.012 | 2.59 | 2.73 | 0 |
| Ex. 30 | bal. | 0 | 40 | 0.7 | 0.7 | 0.05 | 174.8 | 75.4 | 89.9 | 0.011 | 2.60 | 2.81 | 0 |
| Ex. 31 | bal. | 0 | 45 | 0.2 | 0.3 | 0.003 | 166.4 | 76.2 | 78.3 | 0.014 | 2.46 | 2.77 | 0 |
| Ex. 32 | bal. | 0 | 45 | 0.5 | 0.5 | 0.02 | 165.9 | 75.8 | 77.9 | 0.012 | 2.39 | 2.84 | 0 |
| Ex. 33 | bal. | 0 | 45 | 0.7 | 0.7 | 0.05 | 166.8 | 75.5 | 80.1 | 0.011 | 2.40 | 2.79 | 0 |
| Ex. 34 | bal. | 0 | 58 | 0.2 | 0.3 | 0.003 | 139.9 | 70.8 | 72.6 | 0.012 | 2.60 | 2.86 | 0 |
| Ex. 35 | bal. | 0 | 58 | 0.5 | 0.5 | 0.02 | 140.0 | 71.1 | 72.5 | 0.010 | 2.58 | 2.90 | 0 |
| Ex. 36 | bal. | 0 | 58 | 0.7 | 0.7 | 0.05 | 140.3 | 71.7 | 71.8 | 0.011 | 2.55 | 2.84 | 0 |
| Comp. 1 | bal. | 3 | 0 | 0 | 0.5 | 0 | 220.0 | 48.1 | 79.8 | 0.025 | 2.47 | 1.98 | 0 |
| Comp. 2 | bal. | 0 | 30 | 0 | 0 | 0 | 190.7 | 80.8 | 60.0 | 0.095 | 2.39 | 2.02 | 57 |
| Comp. 3 | bal. | 0 | 35 | 0 | 0 | 0 | 181.3 | 79.3 | 73.6 | 0.097 | 2.28 | 1.87 | 55 |
| Comp. 4 | bal. | 0 | 40 | 0 | 0 | 0 | 174.5 | 76.4 | 82.5 | 0.099 | 2.42 | 1.83 | 53 |
| Comp. 5 | bal. | 0 | 45 | 0 | 0 | 0 | 163.5 | 74.4 | 72.4 | 0.093 | 2.31 | 1.87 | 66 |
| Comp. 6 | bal. | 0 | 58 | 0 | 0 | 0 | 140.0 | 69.7 | 65.8 | 0.092 | 2.30 | 2.01 | 59 |
| Comp. 7 | bal. | 0 | 60 | 0 | 0 | 0 | 149.2 | 68.3 | 61.2 | 0.097 | 2.47 | 1.64 | 76 |
| Comp. 8 | bal. | 0 | 35 | 0.1 | 0 | 0 | 181.6 | 78.5 | 75.3 | 0.099 | 2.31 | 1.86 | 60 |
| Comp. 9 | bal. | 0 | 35 | 0.2 | 0 | 0 | 181.9 | 77.6 | 79.0 | 0.089 | 2.47 | 1.89 | 68 |
| Comp. 10 | bal. | 0 | 35 | 0.5 | 0 | 0 | 183.6 | 78.3 | 80.6 | 0.094 | 2.55 | 1.88 | 49 |
| Comp. 11 | bal. | 0 | 35 | 0.7 | 0 | 0 | 184.4 | 79.1 | 80.2 | 0.091 | 2.43 | 1.93 | 53 |
| Comp. 12 | bal. | 0 | 35 | 0.8 | 0 | 0 | 185.1 | 81.4 | 72.8 | 0.095 | 2.35 | 1.84 | 62 |
| Comp. 13 | bal. | 0 | 40 | 0.2 | 0 | 0 | 174.9 | 75.8 | 87.8 | 0.095 | 2.35 | 1.85 | 55 |
| Comp. 14 | bal. | 0 | 40 | 0.5 | 0 | 0 | 175.1 | 75.0 | 92.9 | 0.094 | 2.32 | 1.99 | 47 |
| Comp. 15 | bal. | 0 | 40 | 0.7 | 0 | 0 | 175.7 | 76.0 | 89.3 | 0.092 | 2.19 | 2.00 | 49 |
| Comp. 16 | bal. | 0 | 45 | 0.2 | 0 | 0 | 164.5 | 75.4 | 74.3 | 0.095 | 2.27 | 1.99 | 43 |
| Comp. 17 | bal. | 0 | 45 | 0.5 | 0 | 0 | 166.9 | 76.3 | 79.4 | 0.089 | 2.29 | 1.86 | 56 |
| Comp. 18 | bal. | 0 | 45 | 0.7 | 0 | 0 | 167.3 | 742 | 77.5 | 0.094 | 2.30 | 1.86 | 49 |
| Comp. 19 | bal. | 0 | 58 | 0.2 | 0 | 0 | 139.8 | 70.3 | 69.7 | 0.091 | 2.23 | 2.00 | 55 |
| Comp. 20 | bal. | 0 | 58 | 0.5 | 0 | 0 | 140.2 | 70.6 | 74.9 | 0.094 | 2.31 | 1.97 | 49 |
| Comp. 21 | bal. | 0 | 58 | 0.7 | 0 | 0 | 140.1 | 69.9 | 75.2 | 0.098 | 2.35 | 1.93 | 58 |
| Comp. 22 | bal. | 0 | 35 | 0.2 | 0.2 | 0 | 183.7 | 77.7 | 78.3 | 0.044 | 2.47 | 1.99 | 35 |
| Comp. 23 | bal. | 0 | 35 | 0.5 | 0 | 0.001 | 184.3 | 79.0 | 79.9 | 0.063 | 2.44 | 1.87 | 34 |
| Comp. 24 | bal. | 0 | 35 | 0.5 | 0 | 0.06 | 184.9 | 76.9 | 68.7 | 0.011 | 2.16 | 2.21 | 0 |

Ex. = Example;
M.P = Melting point,
TS = Tensile strength,
El = Elongation
Comp. = Comparative Example;

As shown in Table 1, for each of Examples 1-36, the solder alloy had a melting point of lower than 190° C., a tensile strength of at least 70 MPa, and an elongation of at least 70%. The thickness of the P-rich layer in a solder joint formed on electrodes treated by electroless Ni/Au plating was at most 0.022 μm, and the shear strength was at least 2.21 N on Cu electrodes and at least 2.26 N on electroless Ni/Au plating. The percent exposure of plating when used for soldering to Ni/Au plated electrodes and detached from the electrodes by shearing was 0% for each of the solder alloys.

In contrast, Comparative Example 1, which was a Sn-3Ag-0.5Cu solder alloy, had a high melting point and a low tensile strength, and it had a thick P-rich layer and a markedly decreased shear strength when used for soldering to electrodes treated by electroless Ni/Au plating. Although not shown in Table 1, a large amount of warping of the circuit board was observed after soldering.

For Comparative Examples 2-7 which illustrate Sn—Bi solder alloys, as the Bi content increased, the tensile strength and the elongation deteriorated, the P-rich layer became thicker, the shear strength of a soder joint on electrodes having electroless Ni/Au plating decreased, and the percent exposure of plating became high. Comparative Examples 8-21, which illustrate Sn—Bi—Sb solder alloys, had an overall improvement of tensile strength and elongation compared to the Sn—Bi solder alloys, but the thickness of the P-rich layer was large, the shear strength was poor, and the Ni plating layer was exposed after removal of the solder joint by shearing.

For Comparative Example 22 which had a low Cu content and Comparative Example 23 which had a low P content, the P-rich layer became thick, the shear strength for the electroless Ni/Au plating was poor, and the Ni plating layer was exposed after removal of the solder joint by shearing. For Comparative Example 24 which had too high a P content, the solder alloy had deteriorated elongation, and the shear strength was poor for both unplated Cu electrodes and electroless Ni/Au plating.

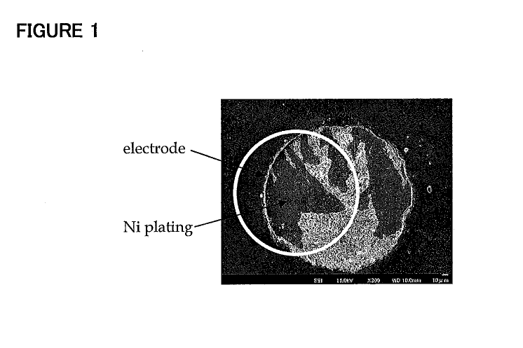

FIG. 1 shows a SEM photograph of a sheared surface of an electrode produced by forming a solder joint on an electrode made of Cu and treated by electroless Ni/Au plating using a Sn-58Bi solder alloy and removing the solder joint by shearing in a shear strength test in the manner described above. In Comparative Examples 2-23, the Ni plating layer was exposed as shown in FIG. 1. This exposure was thought to occur because a P-rich layer grew and fracture by shearing took place at the interface between the P-rich layer and the Ni plating layer.

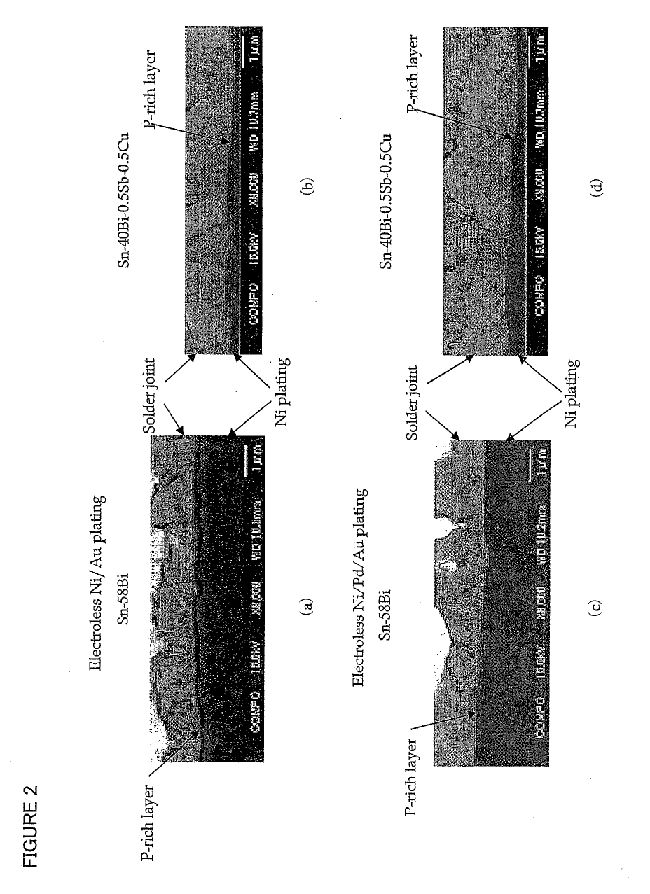

FIGS. 2(a) and 2(b) are SEM photographs of cross sections in the vicinity of the interface between a solder joint and an electrode when a solder joint was formed by soldering of a Cu electrode which had undergone electroless Ni/Au plating using, respectively, a conventional Sn-58Bi alloy and a Sn-40Bi-0.5Sb-0.5Cu alloy according to the present invention, and FIGS. 2(c) and 2(d) are SEM photographs of cross sections in the vicinity of the interface between a solder joint and an electrode when a solder joint was formed by soldering of a Cu electrode which had undergone electroless Ni/Pd/Au plating using, respectively, a conventional Sn-58Bi alloy and a Sn-40Bi-0.5Sb-0.5Cu alloy according to the present invention. From FIGS. 2(a) and 2(c), it is apparent that with a Sn-58Bi solder alloy (Comparative Example 6: shear strength of 2.01 N for electroless Ni/Au plating), a P-rich layer grew because the solder alloy did not contain Cu. In contrast, from FIGS. 2(b) and 2(d), it is apparent that the growth of a P-rich layer was suppressed by the presence of Cu in a Sn-40Bi-0.5Sb-0.5Cu alloy according to the present invention (Example 5: shear strength of 2.96 N for electroless Ni/Au plating). Thus, it can be seen from FIGS. 2(a) to 2(d) that the shear strength was markedly increased by suppressing the growth of a P-rich layer.

1. A lead-free solder alloy having an alloy composition consisting essentially of, in mass percent, Bi: 31-59%, Sb: 0.15-0.75%, at least one element selected from Cu: 0.3-1.0% and P: 0.002-0.055%, and a balance of Sn.

2. A solder joint formed from a lead-free solder alloy according to claim 1 on a Cu electrode having a Ni plated layer.

3. A solder joint according to claim 2 wherein the Ni plated layer is a P-containing electroless plating layer.

4. A substrate having a thickness of at most 5 mm and having a plurality of Cu electrodes each having a Ni plated layer wherein each of the Cu electrodes has a solder joint formed thereon from a lead-free solder alloy according to claim 1.

5. A substrate according to claim 4 wherein the Ni plated layer is a P-containing electroless plating layer.
